(19) United States
(12) Patent Application Publication
(10) Pub. No.: US 2026/0140410 A1
(43) Pub. Date: May 21, 2026

(54) DISPLAY DEVICE

(71) Applicant: LG ELECTRONICS INC., Seoul (KR)

(72) Inventors: Choonhwa LEE, Seoul (KR); Youngjin CHOI, Seoul (KR); Byeonggi MOON, Seoul (KR); Yohan CHOI, Seoul (KR)

(73) Assignee: LG ELECTRONICS INC., Seoul (KR)

(21) Appl. No.: 19/258,446

(22) Filed: Jul. 2, 2025

(30) Foreign Application Priority Data
Oct. 8, 2024 (WO) PCT/KR2024/015304

(51) Int. Cl. G02F 1/1333

(52) U.S. Cl. CPC G02F 1/133314; G02F 1/133305; G02F 1/133325

(57) ABSTRACT

Provided is a display device including a display module, a cover bottom coupled to a rear surface of the display module, a rigid bar coupled to a lower end of the cover bottom and extending in a horizontal direction, a panel substrate positioned on a rear surface of the rigid bar, and a flexible substrate connected to a lower end of the display module at one end thereof, bent rearward under the cover bottom, and connected to the panel substrate at the other end thereof.

This application claims the benefit of PCT International Application No. PCT/KR2024/015304, filed on Oct. 8, 2024, which is hereby incorporated by reference as if fully set forth herein.

### BACKGROUND

### Field

The present disclosure relates to a display device that reduces a manufacturing cost and a weight by simplifying a configuration of a rigid bar of the display device.

### Discussion of the Related Art

With growth of information society, demand for various display devices has increased. In order to satisfy such demand, in recent years, a liquid crystal display (LCD), a field emission display (FED), a plasma display panel (PDP), and an electroluminescent device have been developed as display devices.

A liquid crystal panel of the liquid crystal display includes a liquid crystal layer and a TFT substrate and a color filter substrate opposite each other in the state in which the liquid crystal layer is interposed therebetween, wherein a picture is displayed using light provided from a backlight unit.

Recently, because an element such as an OLED emits light by itself without a backlight structure on a rear surface, a flexible display module may be realized, thereby implementing a curved display device.

As a thickness of the display module becomes smaller, enlargement and weight reduction of the display device are in progress. As the display device becomes thinner and larger, there is a need for a small and light component.

However, as the display device becomes thinner and larger, rigidity of the display device decreases. There is a need for a structure that may supplement the rigidity without increasing the weight and the thickness of the display device.

### SUMMARY

The present disclosure is to provide a display device that reduces a manufacturing cost and a weight by simplifying a configuration of a rigid bar of the display device.

Provided is a display device including a display module, a cover bottom coupled to a rear surface of the display module, a rigid bar coupled to a lower end of the cover bottom and extending in a horizontal direction, a panel substrate positioned on a rear surface of the rigid bar, and a flexible substrate connected to a lower end of the display module at one end thereof, bent rearward under the cover bottom, and connected to the panel substrate at the other end thereof.

The cover bottom may include a seating portion having a front surface where a light source substrate is seated and having a rear surface where a control module is seated, an inclined portion extending forward from the seating portion in an inclined manner, and an edge extending from the inclined portion and positioned on a rear surface of a guide panel of the display module, and the rigid bar may be fastened to at least one of the inclined portion and the edge.

The rigid bar may include a front surface located on a rear surface of the edge, a bottom surface bent rearward from the front surface, and the rear surface extending upward from the bottom surface, and an upper portion of the rigid bar may be open toward the inclined portion.

The front surface and the rear surface may be parallel to each other, and the bottom surface may include an inclined surface with a front end positioned lower than a rear end.

The display device may further include a first bar fastening portion formed on the edge and fastened to the front surface with a screw, and a second bar fastening portion formed on the inclined portion and fastened to the rear surface with a screw, and the first bar fastening portion and the second bar fastening portion may be horizontally misaligned so as not to overlap each other in a thickness direction.

The second bar fastening portion may protrude from the inclined portion and come into contact with a front surface of the rear surface.

The rigid bar may include a concave portion defined at a location of the front surface corresponding to the second bar fastening portion.

The display device may further include a substrate holder fastened to the rear surface and allowing the panel substrate to be inserted thereinto.

The substrate holder may have an upper end extending to the seating portion of the cover bottom, and have a lower end protruding forward to be in contact with the bottom surface of the rigid bar.

The display device of the present disclosure may reduce a manufacturing cost and a weight of a product by reducing the number of rigid bars.

In addition, the display device of the present disclosure may more effectively reinforce the weakest rigidity location by placing the rigid bar on the lower portion of the cover bottom.

In addition, the rigid bar of the display device of the present disclosure may have the fastening holes arranged to be spaced apart from each other in the horizontal direction, and may not need to form the embossed joint for defining the fastening hole in the rigid bar, so that the rigidity may be improved.

Effects obtainable from the present disclosure may be non-limited by the above-mentioned effects. And, other unmentioned effects can be clearly understood from the following description by those having ordinary skill in the technical field to which the present disclosure pertains.

### BRIEF DESCRIPTION OF THE DRAWINGS

FIG. 1 is a front perspective view showing an example of the display device according to the present disclosure;

FIG. 2 is a rear perspective view showing an example of the display device according to the present disclosure;

FIG. 3 is a view illustrating a state in which a back cover of a display device of the present disclosure is separated.

FIG. 4 is a diagram showing an existing arrangement of rigid bars of a cover bottom.

FIG. 5 is a cross-sectional view of a display device of the present disclosure.

FIG. 6 is a diagram showing an example of a placement based on a shape of a rigid bar.

FIG. 7 is a diagram illustrating a rigid bar of a display device of the present disclosure.

FIG. 8 is a diagram illustrating a lower portion of a cover bottom of a display device of the present disclosure.

FIG. 9 is a diagram illustrating a first bar fastening portion and a second bar fastening portion that fasten a rigid bar to a cover bottom.

FIG. 10 is a cross-sectional view illustrating a placement of a substrate holder of a display device of the present disclosure.

### DESCRIPTION OF SPECIFIC EMBODIMENTS

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

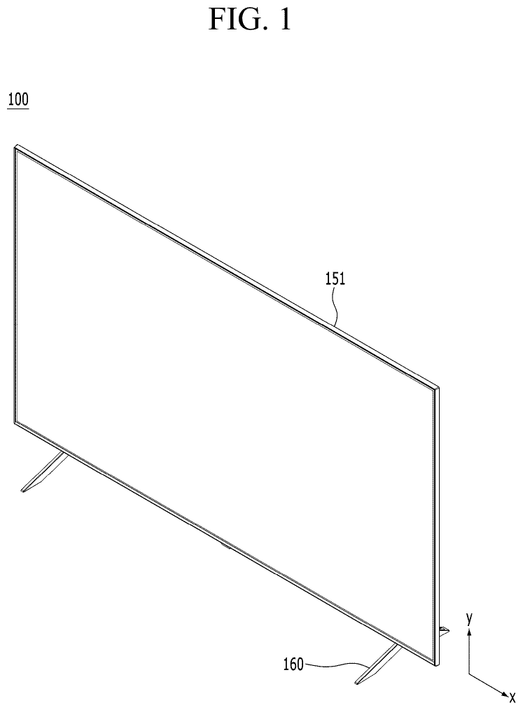

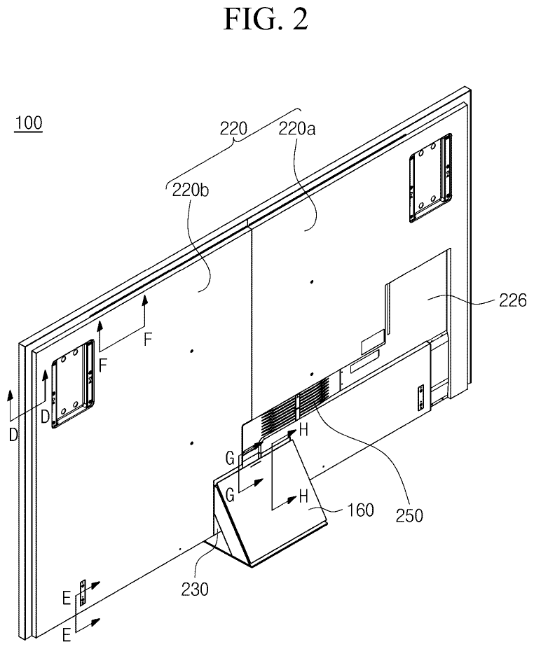

FIG. 1 is a front perspective view illustrating an example of a display device 100, and FIG. 2 is a rear perspective view. As an example of the display device 100, the display device 100 of a large screen having a small thickness is illustrated.

Recently, the display device 100 has been decreased in thickness but increased in size, so that a component thereof is required to have rigidity based on the great size of the device while having a small size. In line with such trend, each component tends to be thinner and miniaturized, but structural improvement thereof is required to ensure the rigidity.

Recently, in a display module 150, as a size of a non-display area located around a display area of a screen has decreased, a bezel has decreased, and a ratio of the screen to the size of the display device 100 has increased. A bezel-less design that seems to have almost no bezel is also being released, and an edge casing that covers a periphery of the display device and forms a side peripheral outer appearance may also be formed in a shape that does not cover a front surface at an upper side and left and right sides, but only covers the front surface at a lower side.

A cover bottom 240 located on a rear surface of the display module 150 and a back cover 220 coupled to a rear surface of the cover bottom 240 have a layered structure.

The display module 150 may have a structure of a plurality of layers composed of a cover bottom 240 positioned on a rear surface thereof and a back cover 220 that forms a rear surface outer appearance of the device while covering various components including a main substrate coupled to a rear surface of the cover bottom 240.

To maintain and repair a control module 180 located on the rear surface of the cover bottom 240, it is necessary to separate the back cover 220 from the cover bottom 240. Accordingly, a coupling structure for fastening the back cover 220 to the cover bottom 240 requires a structure that enables the separation of the components while having a fixing force.

To separate the back cover 220 when inspecting the control module 180 of the display device 100, it is necessary to mount a front surface of the display device 100 facing the floor. Thereafter, a stand assembly 160 coupled to the back cover 220 may be separated from the back cover 220, and the back cover 220 may be separated from the cover bottom 240.

However, as the size of the display device 100 has increased recently, it is difficult to secure a space for seating the display device 100 on the floor indoors. To solve the above problem, the present disclosure provides a rear surface structure of the display device 100 capable of separating the back cover 220 without separating the stand assembly 160. The control module 180 on the rear surface of the cover bottom 240 may be replaced or repaired while the display device 100 of the present disclosure is standing in a vertical direction.

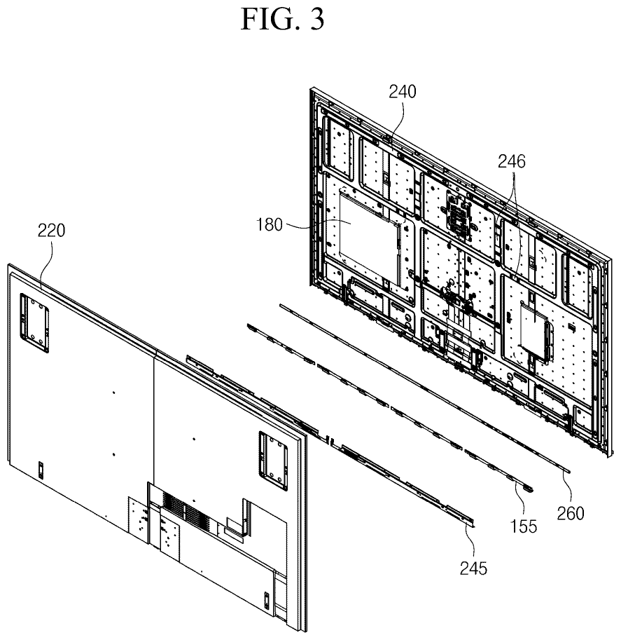

FIG. 3 is a view illustrating a state in which the back cover 220 of the display device 100 of the present disclosure is separated. A rear cover structure of the display device 100 of the present disclosure may be composed of the back cover 220 covering a first area in which the control module 180 is seated and a fixing cover 230 located in a second area to which the stand assembly 160 is fastened.

The fixing cover 230 may be fastened using a screw or the like to have a structure that has a strong fastening force and is not easily separated. The back cover 220 may use a locking structure that enables coupling and separation of components when a predetermined force is applied, such as a latch or a holder.

Although an embodiment in which only one stand assembly 160 is disposed at a center of the display device 100 is shown in FIGS. 2 and 3, a pair of stand assemblies 160 may be disposed to be spaced apart from each other in a left and right direction. In this case, a pair of fixing covers 230 may also be disposed to correspond to the number of stand assemblies 160.

Alternatively, in the case of the display device 100 supported by the pair of stand assemblies 160, after a temporary stand assembly 160 is fastened to the fixing cover 230, the existing stand assembly 160 may be separated to separate the back cover 220 while the display device 100 is standing.

The back cover 220 of the display device 100 of the present disclosure may be composed of two pieces as shown in FIG. 3 in consideration of ease of manufacturing, transportation, and assembly. A first back cover 220a and a second back cover 220b may be arranged adjacent to each other in a left and right direction, and the fixing cover 230 may be positioned between the first back cover 220a and the second back cover 220b.

FIG. 3 is a diagram illustrating a state in which the back cover of the display device 100 of the present disclosure is removed. The cover bottom 240, which is located on front surfaces of the back covers 220a and 220b of the present disclosure and on the rear surface of the display module 150, supports the rear surface of the display module 150 and mounts thereon components that constitute the control module 180, such as a substrate and various cables.

While a size of the display device 100 is increasing, a thickness thereof is decreasing. Further, as the display module 150 is thin, a thickness of the cover bottom 240 is also decreasing. As the thickness of the cover bottom 240 increases, a weight and the thickness of the display device 100 increase and thus a manufacturing cost increases, so that it is necessary to increase rigidity of the cover bottom 240 by another additional method while minimizing the increase in the thickness.

As a first method, a bead 246 may be formed on the rear surface of the cover bottom 240 to improve the rigidity. However, the bead 246 alone achieves a rigidity of 0.6 T of the cover bottom 240, which is insufficient to maintain rigidity of an entirety of the display device 100.

As a second method, a rigid bar 260 may be added to the cover bottom 240 to improve the rigidity of the display device 100. The rigid bar 260 may use a metal bar with a predetermined length made of a rigid material.

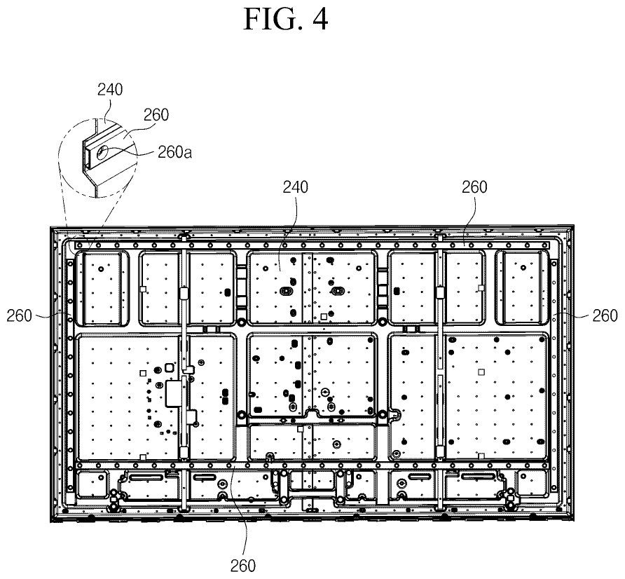

FIG. 4 is a diagram showing an existing arrangement of the rigid bars 260 of the cover bottom 240. The rigid bars 260 were also used to improve the rigidity of the cover bottom 240 in the past, but were arranged in a rectangular shape as shown in FIG. 4.

However, such method has a problem in that a total weight and a material cost increase because of the great number of rigid bars 260. In addition, as shown in the enlarged view, the rigid bar 260 may be formed by folding a plate material that is not solid in a direction parallel to a longitudinal direction in consideration of the weight.

The rigid bar 260 having a □-shaped cross-section is disposed such that an open surface faces the cover bottom 240, and a direction of a front surface thereof becomes an open direction as shown in the enlarged view in FIG. 4. To fasten the cover bottom 240 located on the front surface of the rigid bar 260 with the rigid bar 260, the rigid bar 260 requires an embossed joint 260a that protrudes a fastening portion concavely forward.

When the number of embossed joints 260a is great, the rigidity of the rigid bar 260 decreases, and when the number of embossed joints 260a is small, there is a limitation in transmitting a force that prevents deformation of the cover bottom 240.

Therefore, the present disclosure aims to reduce the number of rigid bars 260 and improve the rigidity thereof by changing the shape and the arrangement of the rigid bars 260 from the existing configuration. Referring to FIG. 3, the display device 100 of the present disclosure may have one rigid bar 260 disposed at a lower end. The display device 100 is the most vulnerable in terms of the rigidity because it includes a complex structure such as a panel substrate 155 being seated at the lower end. However, the present disclosure may sufficiently prevent bending deformation with a smaller number of rigid bars 260 by placing the rigid bar 260 at the weakest rigidity location.

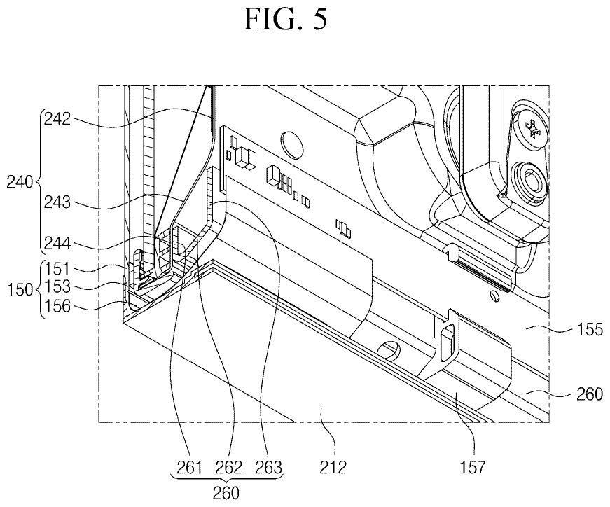

FIG. 5 is a cross-sectional view of the display device 100 of the present disclosure. Referring to FIG. 5, the display module 150 of the present disclosure may have a structure of plurality of layers including a liquid crystal panel 151, and may include a guide panel 153 positioned at a periphery of the display module 150 in a frame shape for alignment of the structure of the plurality of layers.

As shown in FIG. 5, the guide panel 153 may support the layered structure of the display panel 151 and simultaneously fasten a periphery of the cover bottom 240. The cover bottom 240 may include a seating portion 242 having a rear surface on which the control module 180 is seated and having a front surface on which an LED substrate, which is a light source of the display module 150, is seated. The seating portion 242 may occupy a substantial portion of an area of the cover bottom 240 and may include a protruding bead 246 protruding rearward for rigidity or fastening.

An inclined portion 243 extending obliquely forward from a periphery of the seating portion 242, and an edge 244 that is in contact with a rear surface of the guide panel 153 at an end of the inclined portion 243 may be included. The edge 244 may have an end that is bent forward so as to be inserted into the guide panel 153 and fastened. The edge 244 that is fastened to the guide panel 153 may be included.

The rigid bar 260 of the present disclosure may be disposed in a space in contact with a rear surface of the edge 244 and defined under the inclined portion 243. The rigid bar 260 of the present disclosure may include a front surface 261 that is in contact with the rear surface of the edge 244, a bottom surface 262 that is bent in a rearward direction from a lower end of the edge 244, and a rear surface 263 that is bent upward. The rigid bar 260 has the □-shape composed of the front surface 261, the bottom surface 262, and the rear surface 263, and a top surface thereof is open and faces the inclined portion 243 of the cover bottom 240.

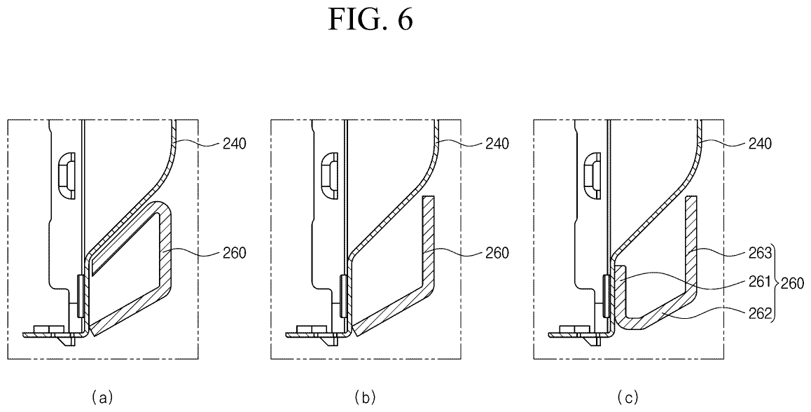

FIG. 6 is a diagram showing an example of a placement based on the shape of the rigid bar 260. When the rigid bar 260 includes a portion that is in contact with the inclined surface as shown in (a) in FIG. 6, an open portion has an undercut shape that is narrow at an entrance and widens inward. The undercut shape has a problem of low mass productivity because of manufacturing difficulties.

As shown in (b) in FIG. 6, the rigid bar 260 may be formed in an L-shape. However, the rigid bar 260 in the present embodiment has a limitation in that it is not able to exhibit sufficient performance as the rigid bar 260 because it has only one folding line and an area size of a member constituting the rigid bar 260 is small.

Accordingly, the present disclosure may use a rigid bar 260 composed of the front surface 261, the rear surface 263, and the bottom surface 262 connecting them to each other as shown in (c) in FIG. 6.

The front surface 261 and the rear surface 263 of the rigid bar 260 may be in parallel with each other, the front surface 261 may be in contact with the rear surface of the edge 244, and the rear surface 263 may form a continuous surface with the seating portion 242 or a plane located slightly forward of the seating portion 242.

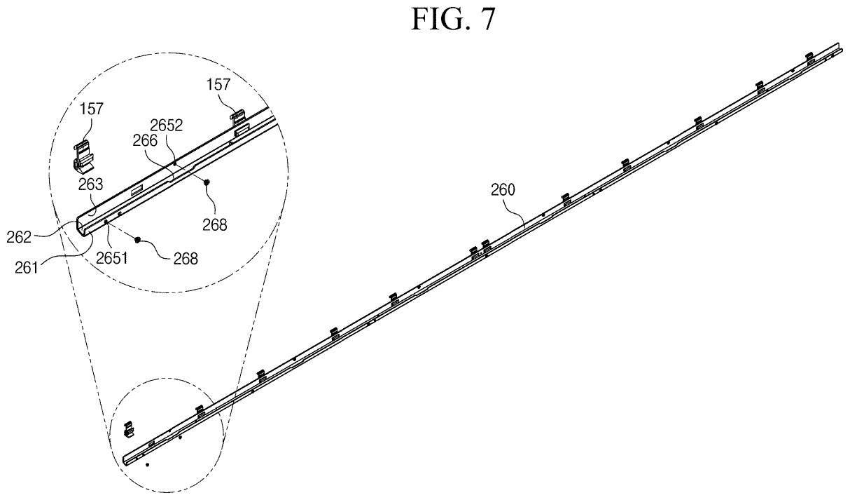

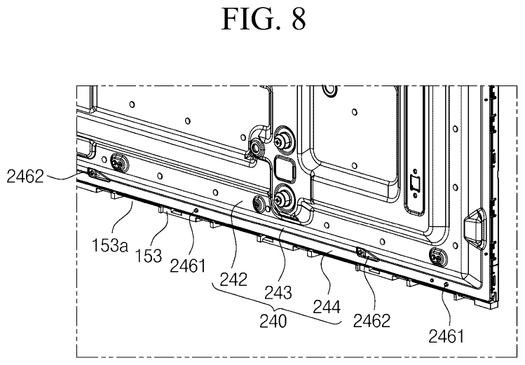

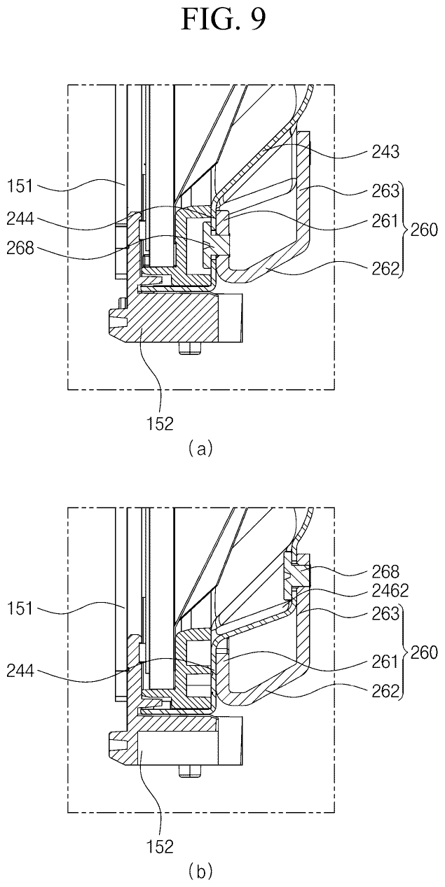

FIG. 7 is a diagram illustrating the rigid bar 260 of the display device 100 of the present disclosure, and FIG. 8 is a diagram illustrating a lower portion of the cover bottom 240 of the display device 100 of the present disclosure. FIG. 9 is a diagram illustrating a first bar fastening portion 2461 and a second bar fastening portion 2462 that fasten the rigid bar 260 to the cover bottom 240.

A structure of fastening the rigid bar 260 of the present disclosure to the cover bottom 240 will be described with reference to FIGS. 7 to 8.

The edge 244 of the cover bottom 240 may include the first bar fastening portion 2461 that fastens the front surface 261 of the rigid bar 260 with a fastening member such as a screw 268. Because the rear surface 263 covers a rear surface of the front surface 261, the front surface 261 and the edge 244 are not able to be fastened to each other at a rear side.

The rigid bar 260 may be fastened by inserting the screw 268 into a first fastening hole 2651 defined in the front surface 261 of the rigid bar 260 in the rearward direction as shown in (a) in FIG. 9 before seating the display module 150 on the cover bottom 240.

When only the front surface 261 of the rigid bar 260 is fastened with the screw 268, a fastening force is weak and there is a limit in preventing the bending deformation of the cover bottom 240. Accordingly, the rear surface 263 of the rigid bar 260 of the present disclosure may also include the second bar fastening portion 2462 (see FIG. 8) protruding on the rear surface of the cover bottom 240 to be fastened to the cover bottom 240. The second bar fastening portion 2462 may protrude on the inclined portion 243 so as to come into contact with a front surface of the rear surface 263 of the rigid bar 260.

As shown in (b) in FIG. 9, the cover bottom 240 and the rear surface 263 of the rigid bar 260 may be fastened to each other by inserting the screw into a second fastening hole 2652 defined in the second bar fastening portion 2462 on the front surface of the cover bottom 240 and the rear surface 263 of the rigid bar 260.

The second fastening hole 2652 located in the rear surface 263 is exposed in a rearward direction, so that the screw may be fastened from the rear, but in this case, the fastening process of the rigid bar 260 should be performed twice at the front surface and the rear surface, and it is necessary to remove a protruding structure on the rear side of the rigid bar 260 for the panel substrate 155 to be seated on the rear surface of the rigid bar 260.

Referring to FIG. 7, the front surface 261 located in front of the second fastening hole 2652 may include a concave portion 266 that is concavely recessed downward. The second bar fastening portion 2462 protrudes rearward as shown in FIG. 8, so that the concave portion 266 is for providing a space through which the second bar fastening portion 2462 may pass.

When the first bar fastening portion 2461 and the second bar fastening portion 2462 are located at the same horizontal location, stress may be concentrated at a similar location. To prevent such problem, the first bar fastening portion 2461 and the second bar fastening portion 2462 may be arranged to be spaced apart from each other in the horizontal direction as shown in FIG. 7.

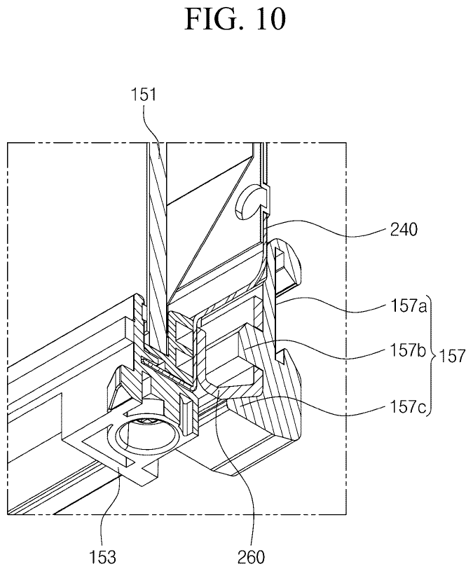

FIG. 10 is a cross-sectional view illustrating a placement of a substrate holder 157 of the display device 100 of the present disclosure. The panel substrate 155 connecting the display module 150 with the control module 180 may be positioned on the rear surface of the rigid bar 260 of the present disclosure. The panel substrate 155 may be positioned at a lower portion of the cover bottom 240 as illustrated in FIG. 5, and may be disposed to partially overlap the rigid bar 260.

A flexible substrate 156 connecting the display module 150 with the panel substrate 155 may extend from a lower end of the display module 150, pass through a space under the cover bottom 240 and the rigid bar 260, and be connected to the panel substrate 155. The guide panel 153 may be partially omitted 153a in an area where the flexible substrate 156 passes as illustrated in FIG. 8, thereby defining a passage portion of the flexible substrate 156.

The substrate holder 157 may be used to fix the panel substrate 155 fastened to the lower portion of the cover bottom 240. The existing substrate holder 157 may be inserted into a holder hole 264 defined in the seating portion 242 or the inclined portion 243 of the cover bottom 240. Conventionally, because of the seating of the panel substrate 155 and the placement of the substrate holder 157, the rigid bar 260 was not able to be disposed on the lower portion of the cover bottom 240.

However, the present disclosure may utilize the shape of the inclined portion 243 to place the rigid bar 260 on the lower portion of the cover bottom 240 and define the holder hole 264 in the rigid bar 260 to fix the substrate holder 157.

The substrate holder 157 may be fixed to the rigid bar 260 by inserting a holder protrusion 157b protruding forward of the substrate holder 157 into the holder hole 264. The substrate holder 157 may include a C-shaped substrate fixing portion 157a that surrounds upper and lower portions of the panel substrate 155. The substrate fixing portion 157a may extend upward of the rigid bar 260 and reach the seating portion 242 of the cover bottom 240 as shown in FIG. 10.

In addition, because one substrate holder 157 is fastened to one holder hole 264, the substrate holder 157 may rotate. A lower end of the substrate holder 157 may be constructed to protrude forward and come into contact with the bottom surface 262 of the rigid bar 260.

The holder hole 264 may be defined so as not to overlap the first fastening hole 2651 and the second fastening hole 2652 described above, and the panel substrate 155 may be fixed to the substrate holder 157 as shown in FIG. 5.

The display device 100 of the present disclosure may reduce a manufacturing cost and a weight of a product by reducing the number of rigid bars 260.

In addition, the display device 100 of the present disclosure may more effectively reinforce the weakest rigidity location by placing the rigid bar 260 on the lower portion of the cover bottom 240.

In addition, the rigid bar 260 of the display device 100 of the present disclosure may have the fastening holes arranged to be spaced apart from each other in the horizontal direction, and may not need to form the embossed joint 260a for defining the fastening hole in the rigid bar, so that the rigidity may be improved.

The above detailed description should not be construed as being limitative in all terms, but should be considered as being illustrative. The scope of the present invention should be determined by reasonable analysis of the accompanying claims, and all changes in the equivalent range of the present invention are included in the scope of the present invention.

What is claimed is:

1. A display device comprising:
a display module;
a cover bottom coupled to a rear surface of the display module;
a rigid bar coupled to a lower end of the cover bottom and extending in a horizontal direction;
a panel substrate positioned on a rear surface of the rigid bar; and
a flexible substrate connected to a lower end of the display module at one end thereof, bent rearward under the cover bottom, and connected to the panel substrate at the other end thereof.

2. The display device of claim 1, wherein the cover bottom includes:
a seating portion having a front surface where a light source substrate is seated and having a rear surface where a control module is seated;
an inclined portion extending forward from the seating portion in an inclined manner; and
an edge extending from the inclined portion and positioned on a rear surface of a guide panel of the display module,
wherein the rigid bar is fastened to at least one of the inclined portion and the edge.

3. The display device of claim 2, wherein the rigid bar includes:
a front surface located on a rear surface of the edge;
a bottom surface bent rearward from the front surface; and
the rear surface extending upward from the bottom surface,
wherein an upper portion of the rigid bar is open toward the inclined portion.

4. The display device of claim 3, wherein the front surface and the rear surface are parallel to each other,
wherein the bottom surface includes an inclined surface with a front end positioned lower than a rear end.

5. The display device of claim 3, further comprising:
a first bar fastening portion formed on the edge and fastened to the front surface with a screw; and
a second bar fastening portion formed on the inclined portion and fastened to the rear surface with a screw,
wherein the first bar fastening portion and the second bar fastening portion are horizontally misaligned so as not to overlap each other in a thickness direction.

6. The display device of claim 5, wherein the second bar fastening portion protrudes from the inclined portion and comes into contact with a front surface of the rear surface.

7. The display device of claim 6, wherein the rigid bar includes a concave portion defined at a location of the front surface corresponding to the second bar fastening portion.

8. The display device of claim 3, further comprising a substrate holder fastened to the rear surface and allowing the panel substrate to be inserted thereinto.

9. The display device of claim 8, wherein the substrate holder has an upper end extending to the seating portion of the cover bottom, and has a lower end protruding forward to be in contact with the bottom surface of the rigid bar.
